(19) United States
(12) Patent Application Publication
(10) Pub. No.: US 2026/0149057 A1
(43) Pub. Date: May 28, 2026

(54) High Voltage Electrolytes for Lithium-Ion Batteries with Micro-Sized Silicon Anode

(71) Applicant: University of Maryland, College Park, College Park, MD (US)

(72) Inventors: Chunsheng Wang, Silver Spring, MD (US); Aimin Li, Hyattsville, MD (US)

(21) Appl. No.: 19/396,856

(22) Filed: Nov. 21, 2025

Related U.S. Application Data
(60) Provisional application No. 63/724,254, filed on Nov. 22, 2024.

(51) Int. Cl. H01M 10/42; H01M 4/02; H01M 4/38; H01M 10/0525; H01M 10/0569

(52) U.S. Cl. CPC H01M 10/4235; H01M 4/386; H01M 10/0525; H01M 10/0569; H01M 2004/021; H01M 2004/027; H01M 2300/0034; H01M 2300/0037

(57) ABSTRACT

The present disclosure is directed to electrolyte compositions for lithium-ion batteries, especially lithium-ion batteries comprising a microsized silicon anode. The electrolyte compositions disclosed herein comprise a lithium salt and a solvent mixture, where the solvent mixture comprises a halogenated ether solvent, a halogenated carbonate solvent, and a sulfone solvent. The present disclosure further relates to lithium-ion batteries comprising the electrolyte compositions, and methods of making and using the same.

### CROSS REFERENCE TO RELATED APPLICATIONS

This application claims priority to U.S. Application No. 63/724,254, filed on Nov. 22, 2024, the contents of which are hereby incorporated by reference in its entirety.

### STATEMENT OF FEDERALLY SPONSORED RESEARCH AND DEVELOPMENT

This invention was made with government support under DE-EE0009183 awarded by the U.S. Department of Energy. The government has certain rights in the invention.

### FIELD OF THE INVENTION

The field of the invention relates generally to batteries and battery technology, in particular to lithium-ion batteries and methods thereof. More particularly, the invention relates to electrolyte compositions for lithium-ion batteries.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Silicon (Si) is a promising anode for lithium-ion batteries (LIBs) to meet the ever-increasing demand for higher energy density. However, large volume changes of the micro-sized Si (μSi) anode during lithiation/de-lithiation cycles produce cracks in both μSi particles and the solid electrolyte interphase (SEI) because the organic-inorganic SEI strongly bonds to the μSi particles and experience the same volume change as μSi. The pulverization of μSi and SEI allow electrolytes to penetrate the cracked μSi and form new SEI, which isolates the pulverized μSi, resulting in a rapid capacity decay. To date, only nano-Si and nano-Si/graphite composite anodes have been used in LIBs, which increases manufacturing costs and reduces the battery calendar life.

Designing a high-voltage carbonate electrolyte that forms a silicon-phobic Li₂O—LiF SEI with weak bonding to μSi particles allowed for a revival of μSi anodes. The high-voltage sulfolane solvent was employed to form Si-phobic Li₂O along with anion-derived LiF, which can achieve high Coulombic efficiency (CE) for both μSi anode and high-voltage NCA cathode. The weakly bonded Li₂O—LiF SEI to μSi particles suffers less stress/strain and maintain their integrity during volume expansion/contraction of μSi particles, which enables 5 μm Si anode with a capacity of 4.1 mAh cm⁻² to achieve a high initial CE of >85%, average cycle CE of >99.8%, and a high specific capacity of 2175 mAh g⁻¹ for >250 cycles at 0.25 C. This non-flammable, high-voltage electrolyte also enables the μSi∥LiNi_{0.8}Co_{0.15}Al_{0.05}O₂ (NCA) full cell to achieve a 200 cycle life, a 100 mAh μSi∥NCA pouch full cell to achieve a high capacity of 172 mAh g_{NCA}⁻¹ for 120 cycles with cycling CE of >99.9% at 0.25 C.

Silicon (Si) alloying anodes hold considerable promise due to their much higher theoretical capacities compared to traditional graphite anodes, thereby increasing the overall energy density of lithium-ion batteries. Additionally, Si anodes do not suffer from lithium metal dendrite formation, which is a common issue leading to safety concerns, such as short circuits or fires. However, the practical application of micro-sized Si anodes faces great challenges due to the substantial volumetric (˜300%) and structural changes that occur during lithiation and de-lithiation cycles. As silicon particles absorb lithium ions, they expand considerably, and during discharge, they contract again. This repeated expansion and contraction can cause particle cracks and pulverization, which degrade the structural integrity of the anode and reduce the battery's cycle life.

To overcome these challenges and obstacles, the electrolyte presented herein focuses on a combination of low-reduction ether solvents and high-reduction LiPF6 salt. This electrolyte formulation promotes the reduction of LiPF6 to form a robust LiF solid electrolyte interphase (SEI) on the surface of the micro-sized Si particles. The LiF SEI has high interfacial energy and weak bonding to the LixSi phases and is critical in enhancing the performance of the micro-sized Si anodes. This weak bonding keeps the SEI to remain intact and allows the inner silicon particles to undergo substantial volume changes. In contrast, traditional SEI layers generated by carbonate electrolytes tend to be organic-rich and more prone to be cracked during cycling. The ability of the LiF SEI to maintain its structural integrity ensures the long-term stability and performance of the micro-sized Si anodes.

This electrolyte design enables the micro-sized Si anodes to achieve a long cycle life with high cycle Coulombic efficiency (CE) of 99.9%. This indicates that the battery can undergo numerous charge/discharge cycles with minimal loss in capacity, making it suitable for commercial applications where durability and consistency are critical. Moreover, micro-sized Si anodes present significant cost advantages compared to nano-sized ones. Nano-sized silicon is expensive to produce and difficult to integrate into large-scale battery manufacturing processes. In contrast, micro-sized silicon is more economical and easier to handle. By enabling the successful cycling of micro-sized Si anodes, this electrolyte design opens up the potential for market shifts toward more affordable and high-energy-density lithium-ion batteries.

### BRIEF DESCRIPTION OF FIGURES

The patent or application file contains at least one drawing executed in color. Copies of this patent or patent application publication with color drawings(s) will be provided by the Office upon request and payment of the necessary fee.

The following drawings form part of the present specification and are included to further demonstrate certain aspects of the present invention. The disclosure may be better understood by reference to one or more of these drawings in combination with the detailed description of specific embodiments presented herein.

FIG. 1. FIG. 1 displays a graph showing the reversibility of SiMP anode covered with silicon-phobic Li₂O—LiF rich SEI or silicon-philic organic-rich SEI during lithiation/de-lithiation cycles. Arrow a. displays a schematic illustration of SiMP electrode cycled in conventional carbonate electrolytes that forms silicon-philic organic-inorganic SEI with strong bonding to Si. Arrow b. displays a schematic illustration of SiMPs electrode cycled in the designed electrolytes that forms silicon-phobic Li₂O—LiF SEI with weak bonding to Si.

FIGS. 2A-2C. FIG. 2 displays measurements of electrolytes solvation of 1.0 M LiPF6/EC-EMC (EE), 1.0 M LiPF6 in FEC-FEMC-TTE (FFT), and 1.0 M LiPF6 in FEC-SL-TTE (FST). FIG. 2A displays Raman spectra in the range of 800-650 cm⁻¹. FIGS. 2B and 2C display in-situ multi-nuclear NMR spectra (FIG. 2B: 7Li-NMR, FIG. 2C: 19F-NMR). All data were collected at room temperature. NMR tuning and shimming using external reference deuterated solvent of D₂O in a co-axis NMR tube.

FIGS. 3A-3C. FIG. 3 displays measurements of the conductivity and electrochemical stability of the electrolytes. FIG. 3A displays the ionic conductivity of FST electrolytes from experiments and MD simulations. FIG. 3B displays the cathodic stability of three electrolytes measured using cyclic voltammetry in Cu∥Li half-cells, the first scan starts from open circuit potential to 0 V v.s Li⁺/Li, the following scans are between 1.5 to 0 V v.s Li⁺/Li. FIG. 3C displays the anodic stability of three electrolytes measured using linear scanning voltammetry in Al∥Li half cell. The scan rate for CV and LSV tests is 0.5 mV s⁻¹.

FIGS. 4A-4D. FIG. 4 displays the cycling performance of SiMP electrodes in μSi∥Li half-cells. FIGS. 4A-4C display typical charge/discharge profiles of the SiMP electrodes cycled in different electrolytes (FST in FIG. 4A, FFT in FIG. 4B, and EE in FIG. 4C). FIG. 4D displays the cycling stability and CEs of SiMPs cycled in FST and reference electrolytes; the cycle rate is C/4 with the first formation cycle at C/20 with the right y-axis representing the areal capacity changes during the cycling.

FIGS. 5A-5F. FIG. 5 displays the Li₂O and LiF distribution on μSi anode in the FFT (FIGS. 5A-5C) and FST (FIGS. 5D-5F) electrolytes. FIGS. 5A and 5D display HR-TEM images, where the colored dots represent the area of corresponding EELS spectral images in FIG. 5C and FIG. 5F. FIG. 5B and FIG. 5E display the mapping of the selected area showing the Li₂O (green) and LiF (blue) distribution. FIG. 5C and FIG. 5F display typical EEL spectra near the surface of the μSi particles with the marked four areas in FIG. 5A and FIG. 5D (from surface to inner layer).

FIGS. 6A-6F. FIG. 6 displays the morphology of Si particles and electrode thickness after cycling. FIGS. 6A-6D display focused ion beam (FIB) cross-section SEM images of the SiMP electrodes after 50 cycles of operation in different electrolytes (FIG. 6A: pristine, FIG. 6B: FST, FIG. 6C: FFT, FIG. 6D: EE). The electrode thickness evolution during the cycling with various electrolytes. FIG. 6E displays the histogram of thickness evolution in the three electrolytes. FIG. 6F displays the SiMPs expansion trend. The dashed line here is only for the guidance of the eye. The μSi∥Li cells are cycled to a specific cycle, then stopped at the charged state to make these ex-situ measurements.

FIGS. 7A-7D. FIG. 7 displays the cycling of the μSi∥NCA full cells. FIGS. 7A-7D display typical charge/discharge profiles of the μSi∥NCA full cells (FIG. 7A: FST, FIG. 7B, FFT, FIG. 7C: EE) and full-cell long cycle performance comparison in the three electrolytes along with the CEs (FIG. 7D). The cycle rate is C/5 at room temperature with the first formation cycle at C/20.

FIGS. 8A-8B. FIG. 8 displays a demonstration of practical μSi∥NCA pouch cell cycling. FIG. 8A displays the μSi full battery performance (areal capacity of ˜4 mAh cm⁻² for NCA and ˜4.1 mAh cm⁻² for μSi, with electrode size ˜5 cm by 5 cm) at room temperature. Before cycling at C/5, one formation cycle at C/20 was conducted. The average CE was calculated from the fifth to the final cycle. FIG. 8B displays the charge/discharge profiles of the μSi∥NCA full cells at the 1^{st}, 5^{th}, 50^{th}, 100^{th}, and 120^{th} cycle. The left inset figure illustrates the test conditions of the assembled pouch cell under the normal pressure of 0.1 MPa, and the right inset shows the actual cell size of 5 cm by 5 cm.

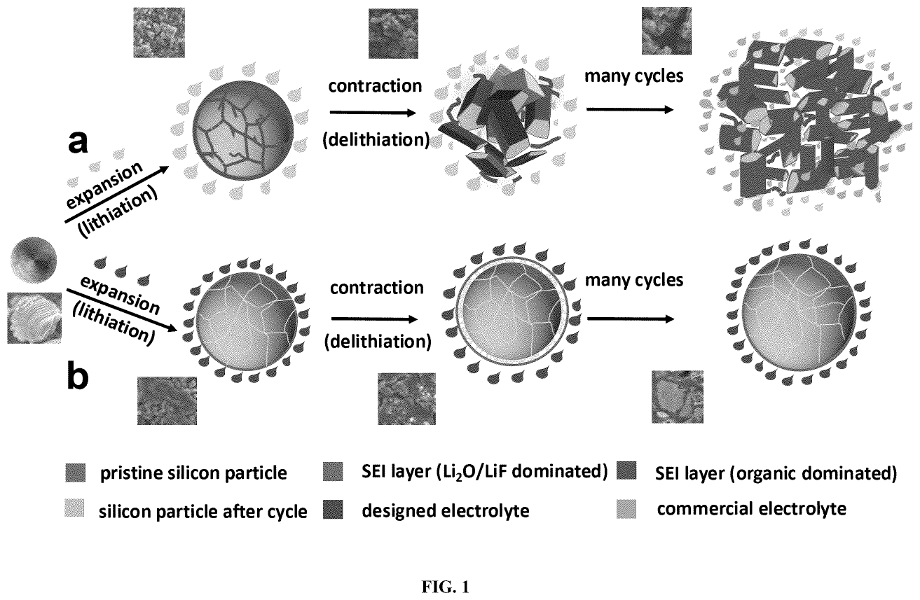

### DESCRIPTION

All publications mentioned herein are incorporated by reference to the extent they support the present invention.

One aspect of the invention pertains to an electrolyte composition for lithium-ion batteries (e.g., lithium-ion batteries with μ-sized Si anodes), said electrolyte composition comprising a solvent mixture and at least one lithium salt; wherein said solvent mixture comprises a halogenated ether solvent, a halogenated carbonate solvent, and a sulfone solvent (e.g. dipropyl sulfone; dimethyl sulfone; butyl sulfone; a cyclic sulfone solvent; e.g., sulfolane).

In some embodiments, the halogenated ether solvent is a fluorinated ether solvent, e.g., TTE; 1,1,2,2-tetrafluoroethyl-2,2,2-trifluoroethyl ether; 1,1,2,2-tetrafluoroethoxy) ethane; or perfluoroisobutyl methyl ether.

In other embodiments, the halogenated carbonate solvent is a fluorinated carbonate solvent, e.g., FEC; difluoroethylene carbonate; trifluoropropylene carbonate; or 4-[(2,2,3,3-tetrafluoropropoxy)methyl]-1,3-dioxolan-2-one.

In further embodiments, the sulfone solvent is dipropyl sulfone; dimethyl sulfone; butyl sulfone; a cyclic sulfone solvent; e.g., sulfolane, or is a cyclic sulfone solvent, such as sulfolane.

In some embodiments, the solvent mixture comprises, by volume, about 20% to about 80% or about 30% to about 50% of halogenated ether, from about 0% to about 20%, or from about 1% to about 5% of halogenated carbonate solvent, and about 10% to about 50%, or about 10% to about 20%, of sulfone solvent. In other embodiments, the solvent mixture comprises halogenated ether solvent, halogenated carbonate solvent, and sulfone solvent at a volume ratio of about 2 parts to 2 parts to 6 parts, respectively.

In some embodiments, the lithium salt is chosen from LiPF₆, LiFSI, LiBF₄, and LiDFOB or combinations thereof (e.g., LiPF₆). The lithium salt may be present at a concentration in the range of about 0.5 M to about 2 M, or about 1 M.

A further aspect of the invention pertains to a lithium-ion battery, said battery comprising a cathode (such as lithium nickel cobalt aluminum oxide (NCA), lithium cobalt oxide (LCO), lithium manganese oxide (LMO), lithium iron phosphate (LFP), NMC811, LiNiO₂), an anode (e.g., a microsized anode, such as microsized Si, Al, Sn, Bi, microsized silicon/carbon composite), and the electrolyte composition disclosed herein. In some embodiments, the carbon composite comprises graphite, hard carbon, soft carbon, or combination thereof.

Another aspect of the invention pertains to a method of assembling a battery of any of the preceding embodiments, said method comprising layering a cathode, an electrolyte composition as disclosed herein, and an anode to obtain multiple layers, wherein said cathode, then said electrolyte composition, then said anode are layered; wherein said cathode, then said electrolyte composition, then said anode are sealed (e.g., mechanically sealed) in a battery casing (e.g., coin cell, or pouch cell).

Yet another aspect of the invention pertains to a method of supplying power, said method comprising using a battery as described previously to supply a voltage in the range of about 2.8 V to about 4.4 V (e.g., about 4.3V) upon discharging.

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “FST”, as used herein, refers to a mixture of solvents used in the electrolytes disclosed herein, comprising fluoroethylene carbonate (FEC), sulfolane (SL), and 1,1,2,2-tetrafluoroethyl-2,2,3,3-tetrafluoropropyl ether (TTE).

The term “halogen” or “halo” as used herein by itself or as part of another group refers to chlorine, bromine, fluorine or iodine.

The term “microsized” as used herein, refers to a material having a particle size of ≥1 μm.

The term “hard carbon” as used herein, refers to char, or non-graphitizing carbon.

The term “soft carbon” as used herein, refers to carbon materials having tunable physical properties.

It is to be understood that both the foregoing descriptions are exemplary, and thus do not restrict the scope of the invention.

### LIST OF EMBODIMENTS

The following is a list of non-limiting embodiments:

1. An electrolyte composition for lithium-ion batteries (e.g., lithium-ion batteries with μ-sized Si anodes), said electrolyte composition comprising a solvent mixture and at least one lithium salt;
wherein said solvent mixture comprises a halogenated ether solvent, a halogenated carbonate solvent, and a sulfone solvent.

2. The electrolyte composition of embodiment 1, wherein said halogenated ether solvent is a fluorinated ether solvent.

3. The electrolyte composition of any of the preceding embodiments, where said fluorinated ether solvent is chosen from TTE, 1,1,2,2-tetrafluoroethyl-2,2,2-trifluoroethyl ether, 1,1,2,2-tetrafluoroethoxy) ethane, or perfluoroisobutyl methyl ether, and combinations thereof.

4. The electrolyte composition of any of the preceding embodiments, where said fluorinated ether solvent is TTE.

5. The electrolyte composition of any of the preceding embodiments, wherein said halogenated carbonate solvent is a fluorinated carbonate solvent.

6. The electrolyte composition of any of the preceding embodiments, wherein said fluorinated carbonate solvent is chosen from FEC, difluoroethylene carbonate, trifluoropropylene carbonate, or 4-[(2,2,3,3-tetrafluoropropoxy)methyl]-1,3-dioxolan-2-one, and combinations thereof.

7. The electrolyte composition of any of the preceding embodiments, wherein said fluorinated carbonate solvent is FEC.

8. The electrolyte composition of any of the preceding embodiments, wherein said sulfone solvent is chosen from dipropyl sulfone, dimethyl sulfone, butyl sulfone, or a cyclic sulfone solvent, and combinations thereof.

9. The electrolyte composition of any of the preceding embodiments wherein said cyclic sulfone solvent is sulfolane.

10. The electrolyte composition of any of the preceding embodiments, wherein said sulfone solvent is sulfolane.

11. The electrolyte composition of embodiment 1, wherein said solvent mixture comprises about 20% to about 80% of said halogenated ether solvent, by volume, about 0% to about 20% of said halogenated carbonate solvent, by volume, and about 10% to about 50% of said sulfone solvent, by volume.

12. The electrolyte composition of any of the preceding embodiments, wherein said solvent mixture comprises about 30% to about 50% of said halogenated ether solvent, by volume.

13. The electrolyte composition of any of the preceding embodiments, wherein said solvent mixture comprises about 1% to about 5% of said halogenated carbonate solvent, by volume.

14. The electrolyte composition of any of the preceding embodiments, wherein said solvent mixture comprises about 10% to about 20% of said sulfone solvent, by volume.

15. The electrolyte composition of embodiment 1, wherein said solvent mixture comprises about 2 parts of said halogenated ether solvent, about 2 parts of said halogenated carbonate solvent, and about 6 parts of said sulfone solvent, by volume.

16. The electrolyte composition of embodiment 1, wherein said at least one lithium salt is chosen from LiPF₆, LiFSI, LiBF₄, and LiDFOB, or combinations thereof.

17. The electrolyte composition of any of the preceding embodiments, wherein said at least one lithium salt is LiPF₆.

18. The electrolyte composition of any of the preceding embodiments, wherein said at least one lithium salt is present at a concentration in the range of about 0.5 M to about 2 M.

19. The electrolyte composition of any of the preceding embodiments, wherein said at least one lithium salt is present at a concentration of about 1 M.

20. A lithium-ion battery, said battery comprising a cathode, an anode, and the electrolyte composition of any of the preceding embodiments.

21. The battery of embodiment 20, wherein said cathode is chosen from lithium nickel cobalt aluminum oxide (NCA), lithium cobalt oxide (LCO), lithium manganese oxide (LMO), lithium iron phosphate (LFP), NMC811, or LiNiO₂, and combinations thereof.

22. The battery of any of the preceding embodiments, wherein said anode is a microsized anode.

23. The battery of any of the preceding embodiments, wherein said anode comprises microsized Si, Al, Sn, Bi, or a microsized silicon/carbon composite, and combinations thereof.

24. The battery of any of the preceding embodiments, wherein said anode comprises microsized Si, microsized Al, microsized Sn, microsized Bi, microsized alloys of Si, Al, Sn, Bi, or combinations thereof, or microsized alloys/carbon composites.

25. The battery of any of the preceding embodiments, wherein said carbon composite comprises graphite, hard carbon, soft carbon, or combinations thereof.

26. The battery of any of the preceding embodiments, wherein said anode comprises microsized Si, and said electrolyte composition comprises FEC, TTE, and sulfolane.

27. The battery of embodiment 26, wherein said FEC, TTE, and sulfolane are present at a volume ratio of 2:6:2, respectively.

28. A method of assembling a battery of any of the preceding embodiments, said method comprising layering a cathode, an electrolyte composition of any of the preceding embodiments, and an anode to obtain multiple layers.

29. The method of embodiment 28, wherein said cathode, then said electrolyte composition, then said anode are layered.

30. The method of any of the preceding embodiments, wherein said cathode, then said electrolyte composition, then said anode are sealed in a battery casing.

31. The method of any of the preceding embodiments, wherein said cathode, then said electrolyte composition, then said anode are mechanically sealed.

32. The method of any of the preceding embodiments, wherein said battery casing is a coin cell or a pouch cell.

33. A method of supplying power, said method comprising using a battery of embodiment 6 to supply a voltage in the range of about 2.8 V to about 4.4 V upon discharging.

34. The method of embodiment 33, wherein said battery supplies a voltage of about 4.3 V upon discharging.

### EXAMPLES

The following examples are provided solely to illustrate the present invention and are not intended to limit the scope of the invention, described herein.

### Example 1. Electrolyte Design for μSi Anodes

The electrolytes for high voltage LIBs using μSi anode should meet certain thresholds to be successful: (1) enable the formation of a silicon-phobic inorganic SEI (such as LiF or Li₂O—LiF composite SEI) that has high interfacial energy and weak binding to LixSi; (2) enable the formation of a LiF-rich cathode electrolyte interphase (CEI) to support high voltage/high capacity cathodes (such as NCA or NMC); (3) have a high ionic conductivity (>10⁻³ S cm⁻¹); and (4) be nonflammable. The designed electrolytes satisfy all the above criteria. The electrolyte design enhances the inorganic LiF/Li₂O while minimizing the organic counterparts in the formed SEI/CEI. The reduction of fluorinated inorganic salts (LiPF₆, LiFSI, etc) forms LiF-rich inorganic SEI, while the reduction of organic solvents will form both organic and inorganic SEI. To reduce the organic components in the SEI, the reduction of solvent should form more inorganic Si-phobic compounds (Li₂O, LiF, etc.) and fewer organic species or can be re-dissolved in the mother electrolytes, leaving inorganic parts accumulated in the final ceramic SEI. SL is a highly polar aprotic solvent (dielectric constant of 43.4 at 303.2 K) with high thermal and anodic stability windows.³⁶ Density functional theory (DFT) calculations suggest that when SL is bound to two Lit, it reduces at 1.3-2 V vs. Li/Li⁺ to form Li₂O at the same potential range as LiF is formed with the reduction of Li⁺(FEC) and TTE. Molecular dynamics (MD) simulation of FST electrolytes discussed below show that ˜4% of SL are indeed coordinated by 2 Li⁺ and would yield Li₂O as a result of the SL (Li⁺)₂ reduction, suggesting SL reduction forms Li₂O to supplement inorganic LiF-rich content in the SEI. In addition, SL has a high solubility for organic SEI and is non-flammable. Formulated with fluorinated FEC and TTE solvents, the FST electrolytes can simultaneously support both μSi anode and high-voltage NCA cathode.

### Example 2. Properties and Solvation Structure of the Electrolytes

The ion coordination environments in 1.0 M LiPF₆/EC-EMC (EE), 1.0 M LiPF₆ in FEC-FEMC-TTE (FFT), and 1.0 M LiPF₆ in FEC-SL-TTE (FST) electrolytes were characterized using Raman and multi-nuclear NMR (⁷Li- and ¹⁹F-) spectroscopies. Raman spectra around 740-750 cm⁻¹ probe PF₆⁻ anion environment due to the blue shift of this Raman band upon Li⁺ complexation. The magnitude of the shift, however, depends on the details of Li⁺ binding to PF₆⁻ anion (monodentate vs. bidentate), complicating the interpretation of the spectra.

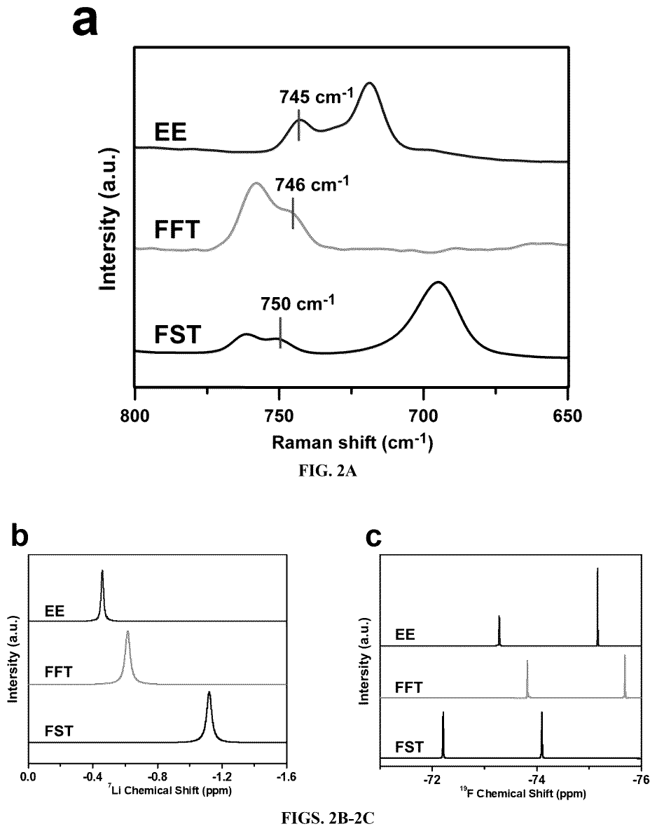

As shown in FIG. 2A, Raman spectra for FFT indicate stronger aggregation than EE electrolytes. Interpretation of FST spectra is complicated because the peaks around 750 cm⁻¹ could correspond to both anion coordinated to one or multiple Li⁺ and to SL/Li⁺ (FIG. 2A). Therefore, in-situ NMR was used to distinguish PF₆⁻/Li⁺ pairing from SL/Li⁺. The upfield shift observed in the 7Li-NMR spectra from EE to FFT to FST is consistent with increasing ion-pairing (EE to FFT) and replacement of stronger Li-SL contacts (FST) compared to Li⁻ (PF₆) (FFT) (FIG. 2B). Likewise, an upfield shift in ¹⁹F spectra is observed from EE to FFT, though it is shifted downfield in FST electrolytes (FIG. 2C), suggesting that PF₆⁻/Li⁺ coordination increases in all-fluorinated FFT electrolytes but decreases when FEMC is replaced by SL due to stronger Li⁺/SL binding energy. Consequently, SL has the highest solvation ability and likely dominates the Li⁺ solvation shell.

MD simulations were used in conjunction with pair distribution functions obtained from a synchrotron X-ray source to further characterize the solvation structure of the FST electrolytes. In accord with the Li⁺(SL)>Li⁺(FEC)>Li⁺(FEMC)>Li⁺(TTE) binding energy trends from DFT, MD simulations predict the Li environment being SL-rich and Li⁺(SL)₄, Li⁺(SL)₃ (FEC), LiPF₆(SL)₃ and LiPF₆(SL)₂(FEC) being the most probable Li⁺ solvates in FST electrolytes. The Li⁺ cation is primarily coordinated by 2.9 SL, 0.8 FEC and 0.7 PF₆⁻ anions on average with a negligible presence of TTE.

The predicted X-ray weighted structure factor from MD simulations for TTE, FEC, SL solvents and FST electrolytes agreed well with the measured ones further validating our electrolyte structure predictions.

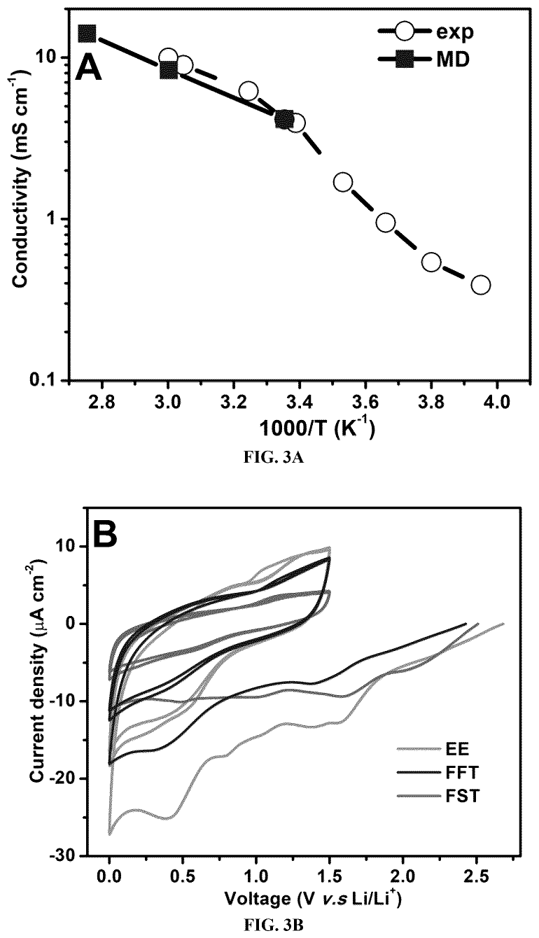

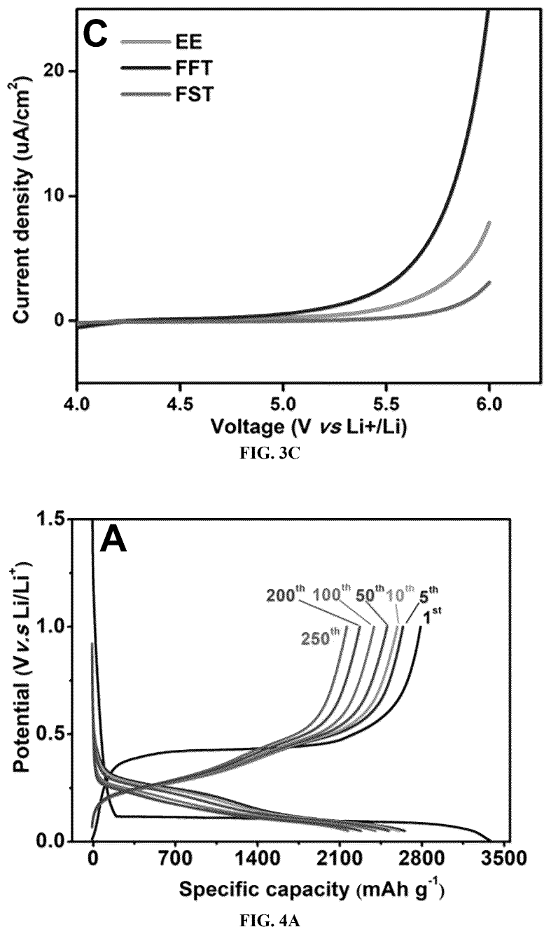

The physical and electrochemical properties of the solvents and three electrolytes are listed in Table 1. The ionic conductivity of FST electrolytes at different temperatures was measured and the conductivity above room temperature agreed well with the MD simulation predictions (FIG. 3A and Table 1). The FST electrolytes have a high ionic conductivity of >4 mS cm⁻¹ at 25° C. and high Li⁺ transference numbers: 0.67 (exp.) and 0.59 (MD simulations). The cathodic and anodic electrochemical stabilities of the three electrolytes were also determined by cyclic voltammetry (CV) and linear sweep voltammetry (LSV), respectively. In the cathodic scans, compared to FFT, the FST electrolytes effectively passivated the Cu electrode after the initial scan, which largely reduced the current density in the following scans due to the formation of Li₂O—LiF SEI (FIG. 3B). Since SL is also an effective electrolyte component for high-voltage cathode batteries, the introduction of SL into the FST electrolytes also boosts its oxidation stability with no obvious current increase observed up to 5.5 V in the Al∥Li half-cell, a value even higher than that of the FFT electrolytes (FIG. 3C). Moreover, because of the flame retardant nature of SL molecule, the FST electrolytes are not flammable and offer improved safety benefits as the FFT electrolytes.

TABLE 1
Properties of solvents and electrolytes at
25° C. from experiments and MD simulations

| | Diffusion | Boiling | | |
|---|---|---|---|---|
| | coefficients | Point | Viscosity | Density |
| Compounds | (10⁻¹⁰ m² s⁻¹) | (1 atm) | (cP) | (g mL⁻¹) |
| EC | — | 248.0 | solid | solid |
| EMC | — | 110 | 0.65 | 1.01 |
| FEC | 1.27 | 210 | 3.85 | 1.41 |
| FEMC | — | 92 | 1.42 | 1.31 |
| TTE | 1.01 | 93.2 | 1.23 | 1.53 |
| SL | 0.88 | 285 | solid | solid |

| | ionic | Li⁺ | | |
|---|---|---|---|---|
| | conductivity | transference | Viscosity | Density |
| Electrolytes | (mS cm⁻¹) | number | (cP) | (g mL⁻¹) |
| EE | 10.17 | 0.37 | 3.12 | 1.27 |
| FFT | 5.12 | 0.50 | 2.15 | 1.51 |
| FST tested | 3.93 (3.6-4.2)^{a} | 0.67 (0.59) | 16.15 (16.8) | 1.47 (1.42) |
| (MD) | | | | |

Note:
EE: 1M LiPF₆-EC-EMC (1:1 by volume); FFT: 1M LiPF₆-FEC-FEMC-TTE (2:6:2 by volume); FST: 1M LiPF₆-FEC-SL-TTE (2:6:2 by volume).
^{a}MD simulations predict conductivity of 3.6 mS cm⁻¹ before finite simulation cell correction and 4.2 mS cm⁻¹ after the finite simulation cell correction was applied.

### Example 3. SEI Compositions on SiMPs

Similar to 1.0 M LiPF₆ in ethylene carbonate-dimethyl carbonate (EC-DMC), 1.0 M LiPF₆/EC-EMC (EE) electrolytes also contain ˜60% of solvent-separated ion pairs (SSIPs), only 40% of contacted ion pairs (CIPs), and few ionic aggregates (AGGs). The reduction of CIPs in the traditional carbonate solvents occurs at potentials close to that of the pure EC and EMC/DMC solvents, forming a mixed organic and inorganic SEI with large separate domains. The fluorination of the carbonate solvents has been attested to enrich LiF content in the SEI components, both on lithium metal surface and silicon electrodes. However, the reduction of fluorinated carbonate solvents also inevitably leads to organic components in the SEI as well, limiting the cycling CE of μSi anode in fluorinated carbonate electrolytes. DFT calculations demonstrated that FEC in 1.0 M LiPF₆ in FEC-SL-TTE (FST) has the highest reduction potential (˜1.9 V) when its fluorine is close to Lit, leading to LiF formation and initial FEC polymerization. The main Li⁺(FEC) reduction when Li⁺is away from fluorine occurs at much lower potentials (˜1 V vs. Li/Li⁺). Without Li⁺ coordination, the reduction of TTE occurs in the range of 1-1.6 V. Li⁺(SL) reduction occurs closer to 0-0.3 V with minimal deformation of the SL; however, recent work by Zheng et al. suggested that the reduced SL.-radical has a much smaller barrier of ring opening than for cycling carbonates such as PC. If this ring opening occurs simultaneously with SL reduction, the reduction potential will increase to ˜1.6 V and may serve as the precursor for Li₂SOₓ species in the SEI. Alternatively, ˜4% of SL molecules are coordinated by 2 Lit, which allows direct Li₂O formation at potentials near 2 V. The reduction of [Li₂SL.]⁺ ring-opened radical, however, does not release Li₂O as loss of oxygen from the terminal SO₂ group is not stable. Similar reduction potentials especially for FEC and SL means LiF and Li₂O will form simultaneously, resulting in the formation of the Li₂O—LiF SEI. SL additionally assists in dissolving organic/polymeric species resulting from the reduction of solvents. Because LiEMC is a typical organic component in SEI, the solubility of LiEMC SEI in EE, FFT, and FST electrolytes was evaluated through 1H-NMR spectra. Neither EE nor FFT electrolytes dissolve LiEMC while it can be dissolved in the FST electrolytes, leaving the Li₂O—LiF dominated SEI, which is further confirmed by XPS spectra.

The SEI composition on the SiMP electrode after cycling in different electrolytes was characterized using XPS with an Art sputtering time (0s, 60s, 120s, 180s, 300s, and 600s). The SiMP electrode was washed with corresponding mother solvents (without salt) before the XPS analysis. Sample preparation and transferring were performed under an inert Ar atmosphere to avoid any contamination from the air. The outer and inner layer of SEI formed in EE and FFT electrolytes mainly consist of organic species (C—O/C—O peak, ˜286.5 eV, C—H/C—C peak, ˜284.8 eV). In comparison, the FFT-SEI has a thinner C—H/C—C peak with a much weaker C—O/C—O intensity than that in EE/FFT electrolytes. Organic species were primarily found in the outer FSI-SEI layer and disappeared after 300s sputtering while the inner layer of FST-SEI was almost exclusively Li₂O—LiF. In the Ols spectra, the FST-SEI showed a much higher Li₂O intensity compared to that in FFT-SEI, and only a negligible Li₂O signal was noticed in the EE-SEI. Instead, the Li₂CO₃ and LiOR signals increased largely for both FFT and EE electrolytes. This result validates that FST electrolytes could promote the formation of Li₂O in the SEI by sulfolane reduction as suggested by the MD simulation. A similar decrease trend was found for the LiF signal in the F1s spectra from FST to FFT and EE electrolytes. The simultaneous formation of Li₂O and LiF in FST electrolytes leads to the desired Li₂O—LiF composite SEI that will be beneficial for the long cycle of SiMPs. The Li₂CO₃ region also widens in FST-SEI, suggesting the presence of Li₂SOₓ species as confirmed in the S2p spectra. The F-content is abundant throughout the etching process for FST-SEI, confirming that a highly inorganic-rich Li₂O—LiF SEI layer is obtained. The presence of crystalline LiF and Li₂O in SEI was also verified by the Fast Fourier Transform (FFT) patterns obtained during high-resolution transmission electron microscopy (HTEM) experiments. The relatively high ratio of F content in FFT-SEI is also in good agreement with the SEI formed on the Li metal anode with the same electrolyte.

### Example 4. Benefits of Li₂O-LI Composite SEI Towards SiMPs

Weak adhesion quantified with Work of Separation (WoS) of different SEI components to LixSi plays a role in stabilizing the SiMP anode. The WoS for Li₂O and LiF to LixSi was calculated through molecular modeling and Li₂CO₃ was also included as a reference, where a low WoS value corresponds to a high interface energy (Eᵢₙₜ). Both LiF and Li₂O have lower WoS values (<0.33 J m⁻²) between different lithiated silicon particles (from Li₁₅Si₄, Li₁₂Si₇ to LiSi) compared to a high WoS value (up to 1.10 J m⁻²) for Li₂CO₃, indicating higher interfacial energies of LiF and Li₂O to the active silicon particles. A region with an ELF value of <0.2 was observed for LiF|LiₓSi and Li₂O|LiₓSi interfaces, referring to the absence of chemical bondings between the interfacial atoms. In contrast, the ELF value between the Li₂CO₃|LiₓSi interface varies from 0 to 0.9, corresponding to the formation of mixed ionic and covalent bonds. The Li₂O and LiF with high Eᵢₙₜ to LiₓSi are Si-phobic and enable the SEI to suffer less stress during the large volume change of SiMPs.

In addition to SEI stabilization, the synergetic effects of LiF and Li₂O also increase the Li-ion conductivity and reduce electron leakage by promoting space charge accumulation along their interfaces. The interstitial defect formed within the lattice Li⁺ ion between LiF and Li₂O was found to boost the interstitial Li⁺ defect concentration in Li₂O lattice near the LiF—Li₂O interface up to 104 times and reduce the electron concentration by a factor of 10⁻⁴ compared to that of the bulk Li₂O. According to a simplified space charge model, when only 5% by volume of LiF was added to Li₂O with a grain size of 15 nm, the ionic conductivity of the SEI increased from 3.0×10⁻⁵ mS cm⁻¹ of Li₂O to 2.0×10⁻³ mS cm⁻¹ in the Li₂O—LiF composite. Further reducing the grain size of Li₂O and increasing the amount of LiF can generate more Li₂O—LiF interface and improve the contribution of space charge effects to total conductivity. Based on this, the total ionic conductivity of Li₂O and LiF composite SEI formed in the FST electrolytes was predicted to be ˜2.5×10⁻² mS cm⁻¹. The interfacial calculation indicates that the high-modulus Li₂O—LiF film not only ensures low bonding between SEI and LiₓSi phases (LiₓSi-phobic) but also promotes space charge accumulation along their interfaces. These effects suppress cracking of SiMPs during cycling and generate a high ionic-to-electronic conductivity ratio, reducing electron leakage and overall SEI thickness to enable high CE and long-cycle stability of SiMPs.

### Example 5. Electrochemical Performance of SiMPs Anode

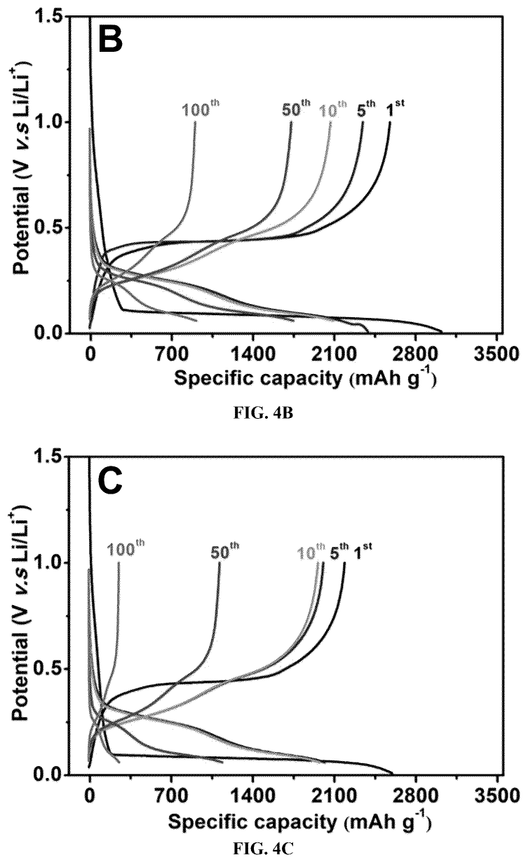

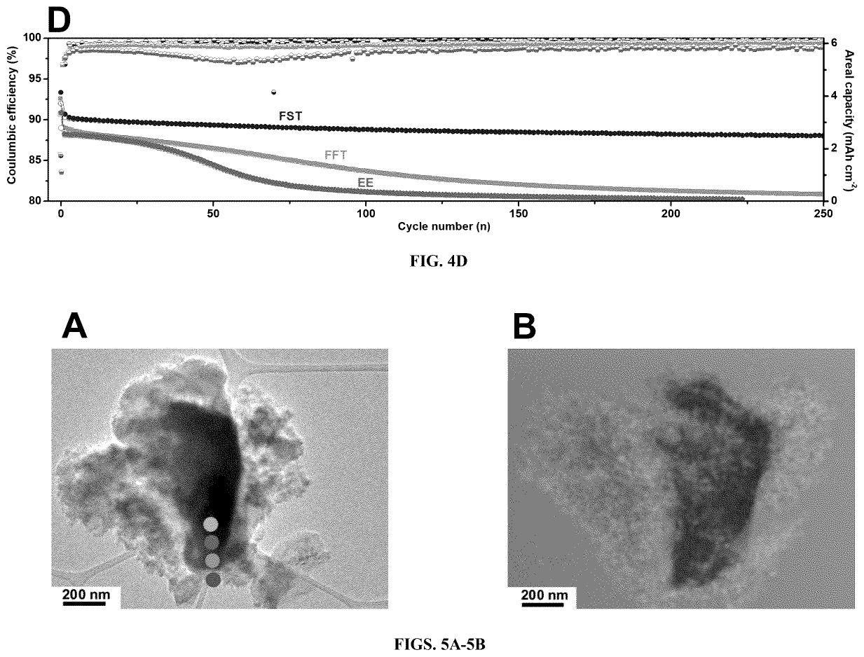

The electrochemical performance of the 5 μm silicon electrode with a ˜1.2 mg cm 2 mass loading was investigated in FST electrolytes between 0.05 V and 1.0 V at a current of 0.25 C in the μSi∥Li coin cells. Before the performance evaluation, the μSi electrode experienced one formation cycle between 0.005 and 1.0 V at a low current of 0.05 C. The performance of the 5 μm Si electrodes in EE and FFT electrolytes was also tested for comparison. The μSi electrodes show a high initial capacity of 4.1 mAh cm⁻² and ˜3,380 mAh g⁻¹ with initial Coulombic efficiency (iCE) of 85.6% in the formation cycle at a current density of 0.05 C, discharge potential of 0.005 V in the FST electrolytes (FIG. 4A). In the following cycles at 0.25 C and discharge potential of 0.05 V, the CE increases to 96.8% at the 2^{nd} cycle and then to 99.3% in the 3^{rd} cycle with an average Coulombic efficiency (aCE) of 99.8% from the 2^{nd} to 250^{th} cycle. The 5 μm Si in FST electrolytes was able to deliver a high capacity of ˜2718 mAh g⁻¹ at 0.25° C. with a capacity retention of over 80% after 250 cycles (FIGS. 4A and 4D). The high and stable capacity of μSi electrode in FST electrolytes are attributed to the silicon-phobic Li₂O—LiF SEI. The weak bonding between Li₂O—LiF SEI and LiₓSi core enables the SEI shell to maintain high stability during large volume changes of the inner Si core, preventing the liquid electrolytes from penetrating cracked Si particles, thus ensuring electrical connection between cracked Si particles. The electrolyte engineering of FST enables the SiMPs to achieve performance better than complicated graphene confinement and elastic binder, and comparable to the performance in low-voltage THF electrolyte.

In contrast, the SiMPs in conventional carbonate EE electrolytes can only release ˜2600 mAh g⁻¹ capacity in the formation cycle at a rate of 0.05 C. The cell capacity quickly decreased to ˜37% of its initial value in only 50 cycles (FIG. 4C) and further dropped to ˜15% (250 mAh g⁻¹) after 100 cycles. The fast capacity decay of SiMPs in commercial carbonate EE electrolytes is attributed to the high organic component in SEI, which cannot accommodate the large volume changes of SiMPs. The CE of SiMPs was only 96-97% in the first several cycles and hovered around 98.0% after the 100^{th} cycle (FIG. 4D). The all-fluorinated FFT electrolytes enable SiMPs to achieve an initial capacity of ˜3033 mAh g⁻¹ with iCE of 85.7% in the formation cycle at 0.05 C but it decreases to 2390 mAh g⁻¹ at 0.25 C in the second cycle. The CE of 5 μm Si in FFT electrolytes increases to 99.1% in the 20^{th} cycle with an average CE of 99.0% from the 2^{nd} to 100^{th} cycle, which is lower than that (99.8%) of FST electrolytes but is higher than that (97%) in commercial carbonate EE electrolytes (FIG. 4C). The improved CE of μSi∥Li cell in FFT is attributed to the increase of LiF in the SEI composition. However, the organic parts from the reduction of fluorinated carbonates still hinder the robustness of the formed SEI. The low CEs of SiMPs in FFT results in continuous capacity fading to 40% in 100 cycles. In addition, the SEI resistance in the EE and FFT electrolytes shows a slight decrease from the first to the fifth cycle due to SiMP fractures with an increase in surface area, followed by an impedance increase due to the continuous growth and thickening of the SEI on the electrode consistent with previous reports. In contrast, the thin and stable SEI formed in FST electrolytes showed small and almost-constant SEI resistance during cycling. Since Li₂O has high interface energy against LiₓSi, replacing μSi by μSiO can further enhance the cycling stability in FST electrolytes, and even in FFT and EE electrolytes. μSiO anode not only reduce the volume change during lithiation/de-lithiation but also reduce the stress.

### Example 6. SiMPs Anode Morphology

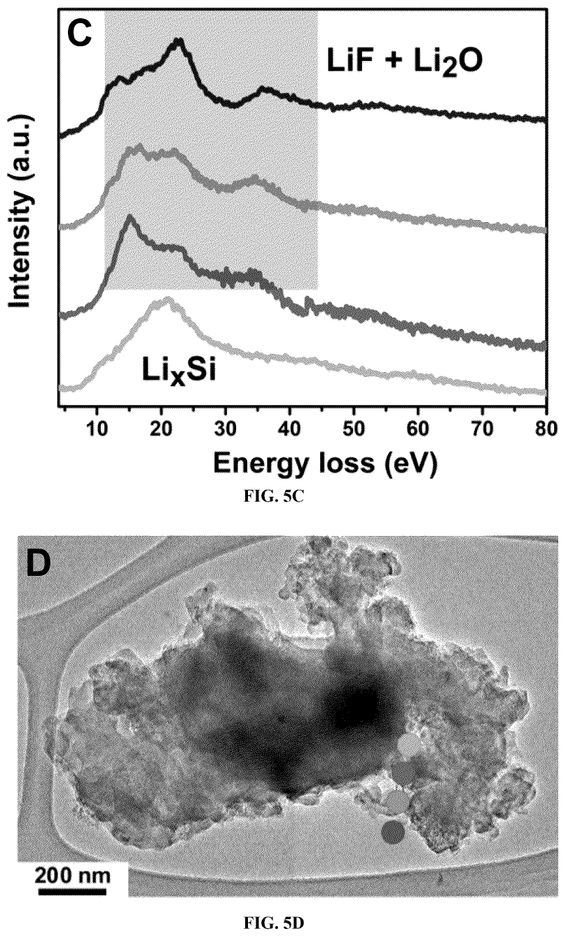

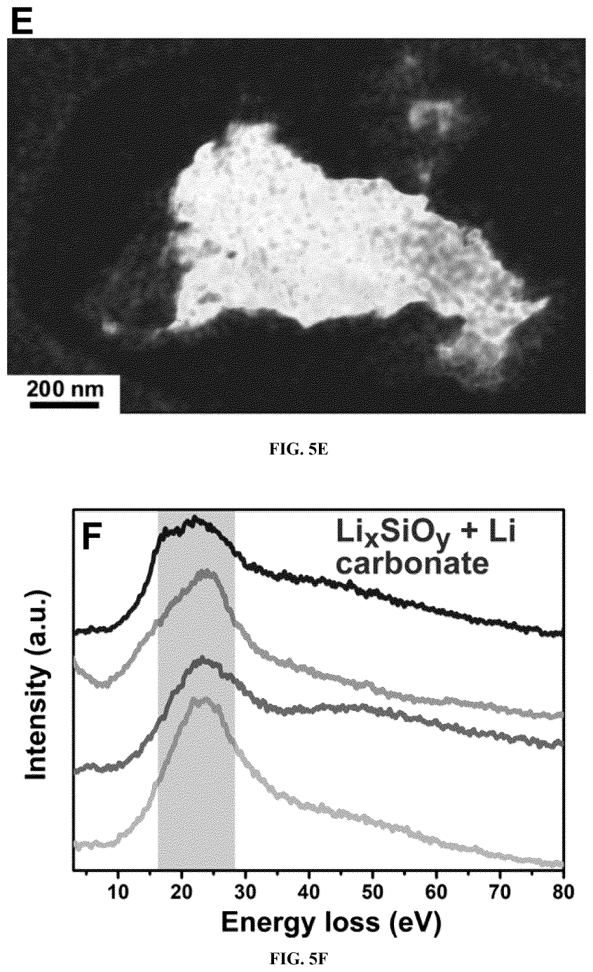

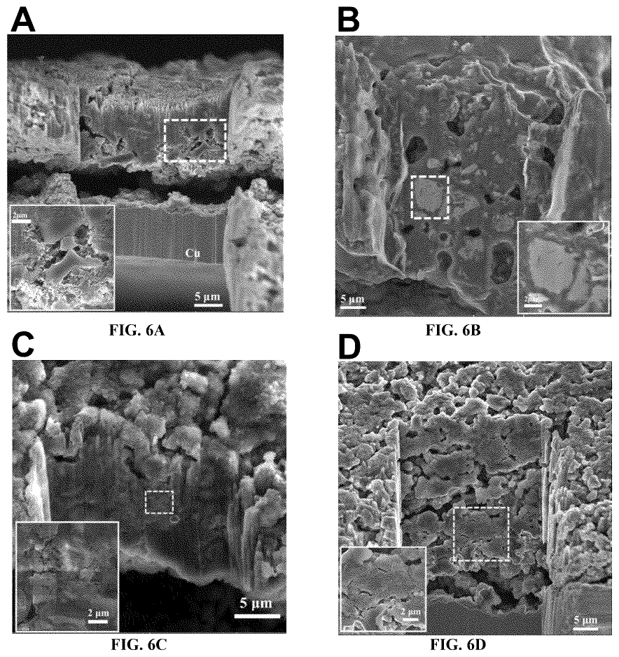

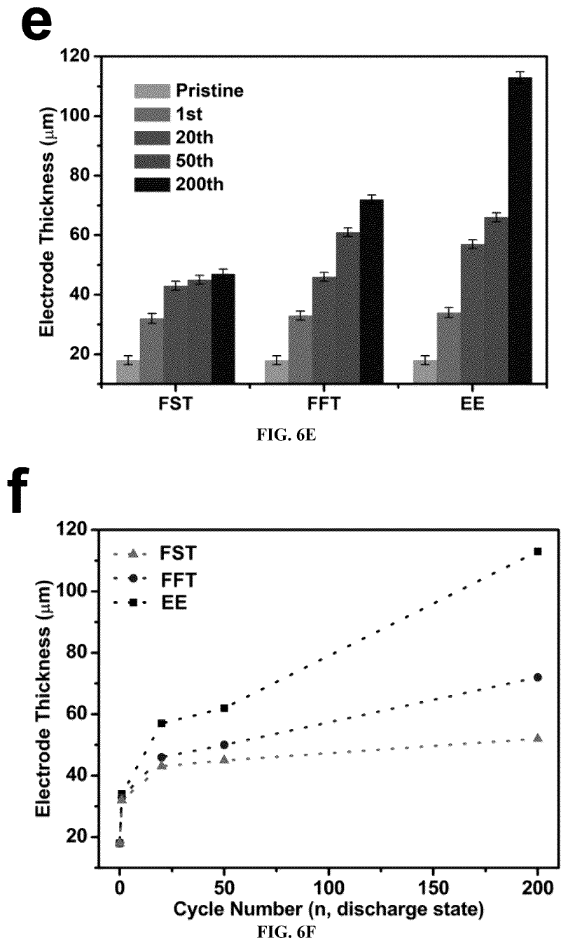

The conformal coating of Si particles by Li₂O—LiF SEI was also examined by electron energy loss spectroscopy (EELS) spectral imaging. The signature differences in valence plasmon energy and peak width among Li compounds in the SEI make the plasmon signals useful to distinguish them from each other easily without suffering from electron beam damage. The EELS spectral images at different locations from the surface to the inside of the SiMPs cycled in FFT and FST electrolytes were analyzed (FIG. 5). The sharp valence plasmon peak at 18.4 eV with a smooth shoulder around 34.5 eV identified the existence of Li₂O signal in SEI, while the sharp peak at 25.7 eV accompanied by a small bump of 15.3 eV is the fingerprint of LiF in the SEI layer. For SiMPs cycled in FST electrolytes (FIGS. 5A and 5C), the Li₂O—LiF was a homogeneous distribution on the Si particle surface with signature signals at 15 eV, 25 eV, and 35 eV, which are in good agreement with the Li₂O—LiF SEI formation mechanism supported by the molecular modeling and XPS analysis. For SiMPs cycled in FFT electrolytes, a mixed organic-inorganic SEI with a broad peak centered around 23 eV is found for almost all the near-surface spectra, which indicates that there is no substantial amount of Li₂O nor LiF on the surfaces (FIG. 5F). The EELS data agrees well with elemental mapping in corresponding cycled SiMPs (FIGS. 5B and 5E). The formation of a fixed Li₂O—LiF SEI shell makes the expansion/contraction of the LiₓSi core more reversible and the electrode thickness remains unchanged after the first few charge/discharge cycles. To validate this stability mechanism, the SiMP morphology and electrode thickness after cycling were evaluated using scanning electron microscopy (SEM) (FIG. 6).

As shown in FIGS. 6A-6D, the SiMPs cycled in FST electrolytes show “crack-less” morphology (FIG. 6B) just like the crack-free pristine Si (FIG. 6A). Only minor fractures can be found in the SiMPs electrode, silicon particles larger than 5 μm could still be noticed after 50 cycles. (FIG. 6B, inset). However, large fractures have developed in SiMPs cycled in the reference electrolytes (FIG. 6C for FFT, FIG. 6D for EE) with almost no micro-sized particles observed in the FIB cross-section of the electrode. The thickness of μSi electrodes after cycling in three electrolytes at different cycles was also measured (FIGS. 6E and 6F). In their pristine state, the cross sections of the SiMP electrodes showed a dense packing of the silicon particles with a thickness of 18 μm (FIGS. 6E and 6F). After cycling, the Si electrode cycled in FFT and EE electrolytes became loosely packed structures and the thickness continuously increased with cycling to reach 72±1 μm and 113±3 μm at 200 cycles, respectively (FIGS. 6E and 6F) due to the continuous formation of SEI in cracked Si. In contrast, the electrode cycled in FST electrolytes showed a more confined dense layer with a thickness of 47±2 μm after 200 cycles, confirming the Si-phobic Li₂O—LiF SEI effectively prevents the electrolyte from penetrating Si particles during lithiation/de-lithiation process (FIGS. 6E and 6F).

### Example 7. μSi∥NCA Full Cell Performance

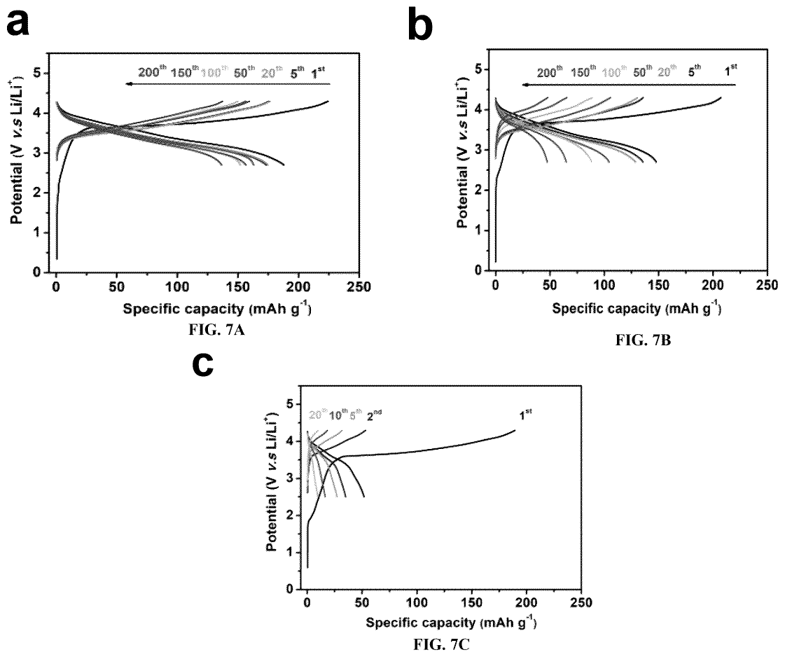

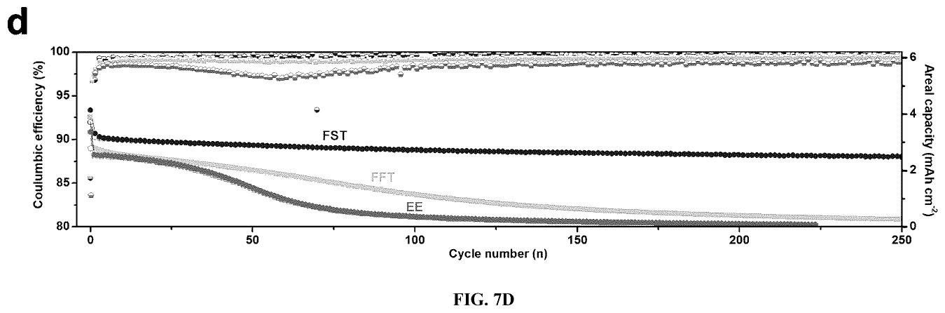

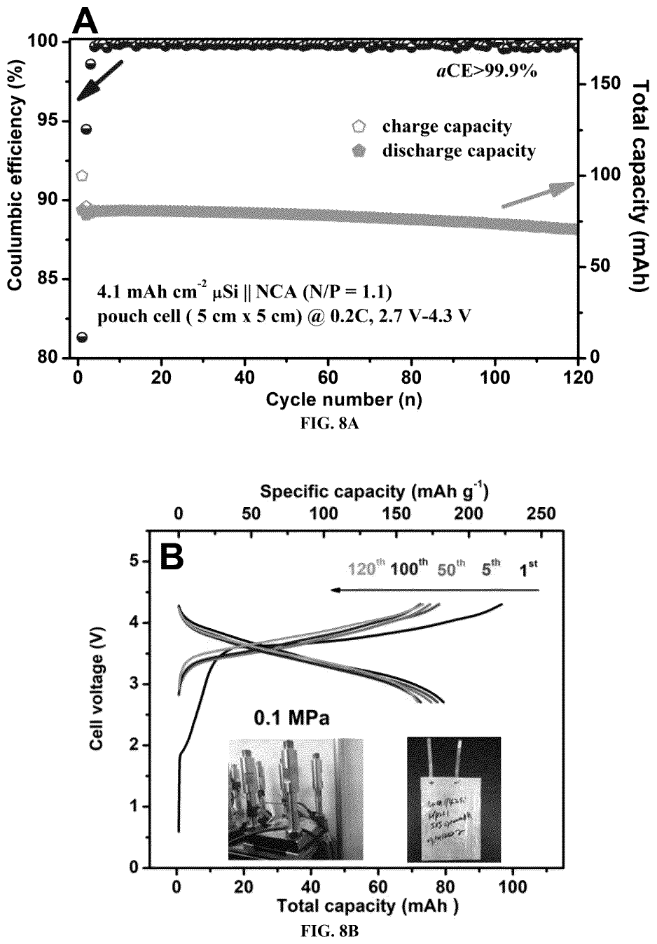

The merits of the FST electrolyte discussed above improve the compatibility of the electrolyte with high-voltage cathodes such as NCA. Thus, the performance of μSi (˜4.1 mAh cm⁻²)∥NCA (4 mAh cm⁻²) full cells was compared with EE, FFT, and FST electrolytes (FIG. 7). Without any precycling nor pre-lithiation and at an N/P ratio of ˜1.1, the μSi∥NCA full cell in FST electrolytes showed an initial discharge capacity of ˜183 mAh g_{NCA}⁻¹ with iCE of 80.1%. No obvious increases in the overpotentials were observed with charge/discharge cycles, which indicates that both the electrodes and their electrode/electrolyte interfaces remain stable during cycling (FIG. 7A). In contrast, under the same cell configuration and cycle conditions, only 151 mAh g⁻¹ and 53 mAh g⁻¹ initial discharge capacity are obtained for μSi∥NCA full cell in FFT and EE electrolytes, respectively (FIGS. 7B and 7C). FST electrolytes also enable a μSi∥NCA full cell to achieve stable cycling (200 cycles, 81% capacity retention) with a high CE of 99.9% (FIG. 7D, blue lines). However, the μSi∥NCA full cell in FFT and EE electrolytes have low iCE of ˜71.3% and 28.1%, respectively. The capacity of μSi|NCA full cell in FFT and EE electrolytes also quickly decayed to <110 mAh g⁻¹ in 50 cycles (FFT) and <30 mAh g⁻¹ in the 3^{rd} cycle (EE) (FIGS. 7B-7D). The severe capacity decay and low CE of μSi∥NCA full cell in FFT and EE electrolytes are attributed to the continuous formation of organic SEI in cracked Si, which also increases charge/discharge voltage hysteresis (FIGS. 7B and 7C). Moreover, the μSi∥NCA full cell in FST electrolyte has a good rate performance due to the high ionic-to-electronic conductivity ratio of the Li₂O—LiF SEI.

A single layer (5 cm by 5 cm) μSi∥NCA pouch cell with an areal capacity of 4 mAh cm⁻² and N/P ratio of 1.1 was evaluated in FST electrolytes without any pre-cycling of the anode or cathode. The practical 100 mAh μSi∥NCA pouch cell exhibits stable cycling with high iCE of 81.3% and an excellent cycle CE (which approaches 99.9% after the fifth cycle) at a current density of C/5, cell pressure of 0.1 MPa, the temperature of ˜25° C. (FIG. 8) The large μSi∥NCA pouch full cell retained 89% of its capacity after 120 cycles in the FST electrolyte, demonstrating its superior cycle stability. This is the first demonstration of a μSi∥NCA pouch full with 100% depth of discharge (DoD), and the performance is the highest among the state-of-the-art μSi anode cells. A comparison of the state-of-the-art battery performances using microsized silicon as the anode, including the batteries and electrolytes presented herein, is given in Table 2.

TABLE 2
Microsized Si anodes in batteries and their comparative performances.

| | μSi | | Loading | Cathodes | Voltage | Cycle | | |
|---|---|---|---|---|---|---|---|---|
| | Size | | (mAh | (N/P | Range | Capacity | | |
| Electrolyte | (μm) | Pretreatments | cm⁻²) | ratio) | (V) | (mAh · g⁻¹) | Cyclability | Ref |
| LP40 | 4.6 | PFM Binder | ~0.67 | none | 0.01 V- | 3200 (0.04 C)/ | Li\|\|μSi: | 1 |
| | | | | | 1 V | 2500 (0.5 C) | No C-rate | |
| | | | | | | | 0%-5 cycles | |
| LP40 | 4.6 μSi + | PFM Binder | ~0.97 | none | 0.01 V- | 3200 (0.04 C)/ | Li\|\|μSi: | 1 |
| | nano | | | | 1 V | 2500 (0.5 C) | No C-rate | |
| | Si | | | | | | 75%-30 | |
| | | | | | | | Cycles | |
| LP40 + 10% | 1-3 | Encapsulated in | ~3.0 | LCO | 0.01 V- | 3300 (0.05 C)/ | μSi\|\|LCO: | 2 |
| FEC + 1% | | graphene cage | | (~1.13) | 1 V; | 1600 (0.5 C) | ~1/3 C | |
| VC | | | | | 3 V- | | 90%-100 | |
| | | | | | 4.2 V | | Cycles | |
| LP40 + 7.5% | ~2.1 | PR-PAA binder | ~3.3 | NCA | 0.01 V- | 2971 (0.033 C) | μSi\|\|NCA: | 3 |
| FEC + 0.5% | | | | (~1.15) | 1.5 V; | 2600 (0.2 C) | 0.2 C | |
| VC | | | | | 2.7 V- | | 98%-50 | |
| | | | | | 4.3 V | | cycles | |
| 1.0M LiPF₆- | 2-6 | HEA-co-DMA | ~1.93 | NMC111 | 0.01 V- | 2850 (0.1 C)/ | μSi\|\|NMC111: | 4 |
| EC/DMC | | binder; 0.5-3 μm | | (~1.1) | 1.2 V; | 2394 (0.25 C) | 0.2 C | |
| (1:1) + 10% | | | | | 2.8 V- | | 80.8%-120 | |
| FEC | | | | | 4.2 V | | cycles | |
| LP40 + 4% | 3-8 | self-healing | 1.5-2.1 | none | 0.01 V- | 2617 (0.1 C)/ | Li\|\|μSi: | 5 |
| FEC | | conductive | | | 1 V | 2500 (0.1 C) | ~1/10 | |
| | | polymer | | | | | 80%-90 | |
| | | | | | | | cycles | |
| 2.0M LiPF₆- | 1-5 | none | ~2.5 | LFP | 0.06 V- | 3200 (0.1 C)/ | μSi\|\|LFP: | 6 |
| MixedTHF | | | | (~0.77) | 1 V; | 2800 (0.2 C) | 0.3 C | |
| | | | | NCA | LFP: | | 80%-100 | |
| | | | | (~0.77) | 2.5 V- | | cycles; | |
| | | | | | 3.45 V; | | Li\|\|NCA: | |
| | | | | | NCA: | | 0.3 C | |
| | | | | | 2.7 V- | | 92%-30 | |
| | | | | | 4.1 V | | cycles | |
| FST | 1-5 | None | ~2 and ~4 | NCA | 0.05 V- | 3380 (0.05 C) | Li\|\|μSi: | This |
| | | | | (~1.1) | 1 V; | >2700 (0.25 C) | 0.25 C 80%- | work |
| | | | | | NCA: | | 250 cycles | |
| | | | | | 2.7 V- | | μSi\|\|NCA | |
| | | | | | 4.3 V | | coin cell: | |
| | | | | | | | 0.2 C, 81%- | |
| | | | | | | | 200 cycles; | |
| | | | | | | | 100 mAh | |
| | | | | | | | pouch cell: | |
| | | | | | | | 0.2 C, 89%- | |
| | | | | | | | 120 cycles | |

Note:
LP40: 1.0M LiPF₆-EC/DEC (1:1 by weight)

### Example 8. CEI Characterization on NCA Cathode

The CEI structure and composition on NCA cathodes were characterized with scanning transmission electron microscopy (STEM) and XPS after the 50^{th} cycle to the fully discharged state in FFT and FST electrolytes. A CEI protecting layer on the primary NCA particles was observed with a CEI thickness ranging from 2-3 nm to 3-8 nm. The CEI composition on cycled NCA was further examined via X-ray photoelectron spectroscopy (XPS). Both CEI films formed in FFT and FST electrolytes showed high F content as evidenced by the F/C and F/O ratios of 0.36/1.3 and 0.47/1.3, respectively, indicating LiF-dominated CEI is formed. The wide band gap (13.6 eV) and high oxidative stability (6.4 V v.s. Li/Li⁺) of LiF ensured effective suppression of the parasitic reactions between the cathode surface and electrolytes. The reduced M-O species (˜529.5 eV, O 1s) and high LiF in CEI formed in FST compared to FFT electrolyte ensure thin CEI thickness and high anti-oxidation stability. In addition, the broad shoulder of the P—O signal (˜529-535 eV) in the FST electrolyte suggests the co-existence of the S—O species, which might come from the decomposition of SL molecules.

### Example 9. Materials and Methods

Lithium hexafluorophosphate (LiPF₆, >99.99%) salt was purchased from Gotion, and Li chips with a thickness of 250 μm were purchased from MTI Corporation. The reference electrolyte 1.0 M LiPF₆ in EC/EMC=50/50 (v/v) (battery grade) and Fluoroethylene carbonate (FEC, 99%) were bought from Sigma-Aldrich. Methyl (2, 2, 2-trifluoroethyl) carbonate (FEMC, >98%), 1,1,2,2-Tetrafluoroethyl 2,2,3,3-Tetrafluoropropyl Ether (TTE, >97%) and Tetramethylene sulfone (SL, >99%) were purchased from TCI, US. All the solvents were dried over activated molecular sieves (4 Å, Sigma-Aldrich) to make sure the water content is less than 10 ppm (Karl-Fisher titrator, Metrohm 899 Coulometer). The LiNi_{0.8}Co_{0.15}Al_{0.05}O₂ (NCA) cathodes coated on Al foil with a loading of 4.0 mAh cm⁻² were kindly provided by Saft America, Inc.

The reference electrolyte “EE” [1.0 M LiPF₆ in EC/EMC=50/50 (v/v) (battery grade, Sigma)] was used as received, and the all fluorinated electrolyte was prepared by first mixing the pure solvents FEC, FEMC, and TTE with a volume ratio of 2:6:2, then 1.0 M LiPF₆ was dissolved in the obtained mixture to get the “FFT” electrolyte. To prepare the “FST” electrolyte, a homogeneous solution of FEC, SL, and TTE by the volume ratio of 2:6:2 was first obtained by mixing the corresponding solvents. Then 1.0 M LiPF₆ was dissolved in the prepared mixture to get the “FST” electrolyte. The molarities here were calculated based on the moles of salt added and the volumes of solvents used. The ionic conductivities of the electrolytes were calculated by electrochemical impedance spectroscopy measurements with two platinum plate electrodes (1 cm²) symmetrically placed in the electrolyte solutions.

For the SiMP electrodes, a slurry was first prepared by dispersing SiMPs (1-5 μm, TCI, US, as-received), lithium polyacrylate binder (10 wt % aqueous solutions) and Ketjen black in water with a weight ratio of 6:2:2. The slurry was cast onto a copper (Cu) foil, dried at room temperature for 24 h and further dried at 90° C. overnight under vacuum. μSi electrodes with a loading of 1.2 mg cm⁻² (corresponding to 4.3 mAh cm⁻² from a theoretical value of 3579 mAh gsi⁻¹) were obtained. The μSi electrode processing is the same as that of commercial graphite electrodes without any additional pretreatment or pre-lithiation. CR2032 coin-type half-cells were assembled by sandwiching one piece of Celgard 3501 separator between the SiMP electrodes and Li metal foil. The electrolytes used for cell assembly were: (1) “EE” [1.0 M LiPF₆ in EC/EMC=50/50 (v/v)]; (2) “FFT” 1.0 M LiPF₆ in FEC/FEMC/TTE=20/60/20 (v/v/v); and (3) “FST”-1.0 M LiPF₆ in FEC/SL/TTE=20/60/20 (v/v/v).

In the galvanostatic cell tests, the current density was set at 0.25 C (1C=theoretical capacity) in the potential range 0.05-1.0 V v.s Li/Li⁺ using a battery cycler (Landt Instrument). For all electrolytes, one activation cycle with a voltage cutoff of 0.005 V was performed before the cycling test with a 0.05 C rate. Both the specific capacities and current densities are based on the SiMP mass only. Linear sweep voltammetry (LSV) and cyclic voltammetry (CV) with different scan rates or voltage ranges were conducted on a CHI 600E electrochemical workstation (CH Instruments Inc. USA). The ¹⁹F-, and ⁷Li-NMR spectra were recorded on a Varian Mercury 400 MHz NMR spectrometer at room temperature. The Horiba Jobin Yvon Labram Aramis with a 532 nm diode-pumped solid-state laser was used for Raman measurements. Li⁺ transference number (LTN), and electrochemical impedance spectroscopy (EIS) were tested on a Gamry 1000E electrochemical workstation (USA) The electrochemical impedance spectroscopy measurements were taken over a frequency range of 1 MHz to 0.1 Hz. The transference number t⁺ was calculated by the following equation:

$${t}_{+} = \frac{{I}_{s} ( ΔV - {I}_{0} {R}_{0} )}{{I}_{0} ( ΔV - {I}_{s} {R}_{s} )}$$

where ΔV is the voltage polarization applied, Iₛ and Rₛ are the steady-state current and resistance, I₀ and R₀ are the initial current and resistance, respectively. The applied voltage bias for the LTN tests in the Li|Li cells here was 10 mV.

For SEM imaging of the electrodes after cycling, the electrodes were washed with corresponding mother liquor (without adding salt) to remove any residual Li salts from the surface of the electrodes and vacuum-dried before the sample transferring to Hitachi SU-70 field emission SEM or a JEOL 2100F field emission for the morphologies characterization. The high-resolution transmission electron microscopy (HRTEM) was performed with a Hitachi HD2700C at the NanoCenter of the University of Maryland, College Park. The ToF-SIMS attached with a Ga⁺ focused ion beam (FIB)/SEM (Tescan GAIA3) was employed to do the ion sputtering. For STEM-EELS characterization, the JEOL-2100F FEG STEM equipped with energy-dispersive spectroscopy (EDS, Oxford INCA series) and Gatan image filter (GIF, Tridiem 863) is used.

For full cell tests, NCA cathodes coated on Al foil (4.0 mAh cm⁻²) were kindly provided by Saft America Inc. The cells were charged with a cutoff voltage of 2.7-4.3 V, the assembled full cell has an N/P ratio of ˜1.1. The 100 mAh homemade pouch cell is fabricated inside a glovebox, where aluminum and nickel strips were attached as electrode tabs to the sides of the cathode and anode, respectively. The electrolyte addition for each pouch cell was 3 g Ah⁻¹. The electrolyte was dropped into the package through a pipette, followed by the sealing of the battery under vacuuming. The large pouch cell was cycled between 2.7 and 4.3 V on an Arbin battery test station (BT2000, Arbin Instruments) that is stored in a 25° C. testing room.

For XPS tests, data were collected using the K-Alpha X-ray Photoelectron Spectrometer System (Thermo Scientific™, Al Kα radiation, hv=1486.68 eV) at the University of Rhode Island. The sample preparation is the same as the SEM test. The sample was directly moved from the Ar atmosphere to the XPS chamber with a vacuum transfer container to avoid exposure to the air. The neutralizer was applied during the data collection, and an Ar sputter gun was used for the etching with the ion energy set at 200 eV and the middle range current selected. The sputtering rate was estimated to be ˜0.01 nm s⁻¹. The etching procedure was carried out in a cycle of accumulated 0, 60, 120, 180, 300, and 600 seconds. Spectra were recorded of the sample surface before sputtering and between sputtering cycles. All data was calibrated based on the C1s peak to 284.8 eV for binding energy values. Peak fitting and relative atomic percentage estimation were done using CasaXPS software (version 2.3.24), after accounting for the relative sensitivity factors (R.S.F) of Thermo K-Alpha.

For PDF measurements. Electrolyte solvent, salt, and electrolyte solution were packed inside polyimide capillary tubes sealed by epoxy glue on both sides. The PDF measurements were carried out at the 28-ID-2 beamline of National Synchrotron Light Source II (NSLS II) In Brookhaven National Laboratory (BNL) using a photon wavelength of 0.1818 Å. The obtained data were integrated using Fit2D software. The PDF and G(r) values were extracted using PDFgetX3 software.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
1. Yang, C. et al. Aqueous Li-ion battery enabled by halogen conversion-intercalation chemistry in graphite. Nature 569, 245-250 (2019).
2. Chu, S. et al. Opportunities and challenges for a sustainable energy future. Nature 488, 294-303 (2012).
3. Armand, M. et al. Building better batteries. Nature, 451 652-657 (2009).
4 Battery revolution to evolution. Nature Energy 4, 893-893 (2019).
5. Wu, F. et al. Guidelines and trends for next-generation rechargeable lithium and lithium-ion batteries. Chem Soc Rev 49, 1569-1614 (2020).
6. Li, W. et al. High-voltage positive electrode materials for lithium-ion batteries. Chem Soc Rev 46, 3006-3059 (2017).
7. Choi, J. W. et al. Promise and reality of post-lithium-ion batteries with high energy densities. Nature Reviews Materials 1 1-6 (2016).
8. Obrovac, M. N. et al. Alloy Design for Lithium-Ion Battery Anodes. J Electrochem Soc 154, A849 (2007).
9. Ji, L. et al. Recent developments in nanostructured anode materials for rechargeable lithium-ion batteries. Energy Environ Sci 4, 2682 (2011).
10. Chan, C. K. et al. High-performance lithium battery anodes using silicon nanowires. Nature Nanotechnology 3, 31-35 (2008).
11. Liu, Z. et al. Silicon oxides: a promising family of anode materials for lithium-ion batteries. Chem Soc Rev 48, 285-309 (2019).
12. Liu, X. H. et al. Anisotropic swelling and fracture of silicon nanowires during lithiation. Nano letters 11, 3312-3318 (2011).
13. Kim, H. et al. A critical size of silicon nano-anodes for lithium rechargeable batteries. Angewandte Chemie 49, 2146-2149 (2010).
14. Zhu, T. et al. Formation of hierarchically ordered structures in conductive polymers to enhance the performances of lithium-ion batteries. Nature Energy 1-9 (2023).
15. Xu, Z. et al. Silicon Microparticle Anodes with Self-Healing Multiple Network Binder. Joule 2, 950-961 (2018).
16. Kovalenko, I. et al. A major constituent of brown algae for use in high-capacity Li-ion batteries. Science, 334 75-79 (2011).
17. Wang, C. et al. Self-healing chemistry enables the stable operation of silicon microparticle anodes for high-energy lithium-ion batteries. Nature Chemistry 5, 1042-1048 (2013).
18. Choi, S. et al. Highly elastic binders integrating polyrotaxanes for silicon microparticle anodes in lithium ion batteries. Science, 357 279-283 (2017).
19. Li, Y. et al. Growth of conformal graphene cages on micrometre-sized silicon particles as stable battery anodes. Nature Energy 1, 1-9 (2016).
20. Zhang, C. J. et al. High capacity silicon anodes enabled by MXene viscous aqueous ink. Nat Commun 10, 849 (2019).
21. Son, I. H. et al. Silicon carbide-free graphene growth on silicon for lithium-ion battery with high volumetric energy density. Nat Commun 6, 7393 (2015).
22. Magasinski, A. et al. High-performance lithium-ion anodes using a hierarchical bottom-up approach. Nat Mater 9, 353-358 (2010).
23. McBrayer, J. D. et al. Calendar aging of silicon-containing batteries. Nature Energy 6, 866-872 (2021).
24. Chen, J. et al. Electrolyte design for LiF-rich solid-electrolyte interfaces to enable high-performance microsized alloy anodes for batteries. Nature Energy 5 386-397 (2020).
25. Qian, J. et al. High rate and stable cycling of lithium metal anode. Nat Commun 6, 6362 (2015).

26 Fan, X. et al. Highly Fluorinated Interphases Enable High-Voltage Li-Metal Batteries. Chem 4, 174-185 (2018).
27. Choi, J. et al. Weakly Solvating Solution Enables Chemical Prelithiation of Graphite-SiO (x) Anodes for High-Energy Li-Ion Batteries. J Am Chem Soc 143, 9169-9176 (2021).
28. Yang, G. et al. Robust Solid/Electrolyte Interphase (SEI) Formation on Si Anodes Using Glyme-Based Electrolytes. ACS Energy Letters 6, 1684-1693 (2021).
29. Chen, L. et al. High-Energy Li Metal Battery with Lithiated Host. Joule 3, 732-744 (2019).
30. Piwko, M. et al. Enabling electrolyte compositions for columnar silicon anodes in high energy secondary batteries. Journal of Power Sources, 362, 349-357 (2017).
31. Alvarado, J. et al. A carbonate-free, sulfone-based electrolyte for high-voltage Li-ion batteries. Materials Today 21, 341-353 (2018).
32. Huang, Q. et al. Supremely elastic gel polymer electrolyte enables a reliable electrode structure for silicon-based anodes. Nat Commun 10, 5586 (2019).
33. Li, Y. et al. Revealing the size-dependent electrochemical Li-storage behaviors of SiO-based anodes. Journal of Materials Chemistry A 10, 23770-23779 (2022).
34. Miyachi, M. et al. Analysis of SiO Anodes for Lithium-Ion Batteries. J Electrochem Soc 152, A2089 (2005).
35. Pang, Y. et al. Electrolyte/Electrode Interfaces in All-Solid-State Lithium Batteries: A Review. Electrochemical Energy Reviews 4, 169-193 (2021).
36. Xu, K. Nonaqueous liquid electrolytes for lithium-based rechargeable batteries. Chemical reviews, 104 4303-4418 (2004).
37. Han, S. D. et al. Solvate Structures and Computational/Spectroscopic Characterization of LiPF₆ Electrolytes. J. Phys. Chem. C 119, 8492-8500 (2015).
38. Seo, D. M. et al. Electrolyte Solvation and Ionic Association II. Acetonitrile-Lithium Salt Mixtures: Highly Dissociated Salts. J Electrochem Soc 159, A1489-A1500 (2012).
39. Li, Z. et al. Nonvolatile and Nonflammable Sulfolane-Based Electrolyte Achieving Effective and Safe Operation of the Li—O2 Battery in Open 02 Environment. Nano letters 22, 815-821 (2022).
40. Fan, X. et al. Non-flammable electrolyte enables Li-metal batteries with aggressive cathode chemistries. Nature Nanotechnology 13, 715-722 (2018).
41. Zheng, J. et al. 3D visualization of inhomogeneous multi-layered structure and Young's modulus of the solid electrolyte interphase (SEI) on silicon anodes for lithium ion batteries. Phys Chem Chem Phys 16, 13229-13238 (2014).
42. Wang, L. et al. Identifying the components of the solid-electrolyte interphase in Li-ion batteries. Nature Chemistry 11, 789-796 (2019).
43. Danet, J. et al. Valence electron energy-loss spectroscopy of silicon negative electrodes for lithium batteries. Phys Chem Chem Phys 12, 220-226 (2010).
44. Boniface, M. et al. Nanoscale Chemical Evolution of Silicon Negative Electrodes Characterized by Low-Loss STEM-EELS. Nano letters 16, 7381-7388 (2016).
45. Richards, W. D. et al. Interface Stability in Solid-State Batteries. Chem Mater 28, 266-273 (2015).
46. Fairley, N. et al. Systematic and collaborative approach to problem solving using X-ray photoelectron spectroscopy. Applied Surface Science Advances 5, 100112 (2021).
47. Hammersley, A. P. FIT2D: a multi-purpose data reduction, analysis and visualization program. J Appl Crystallogr 49, 646-652 (2016).
48. Kresse, G. et al. Efficient iterative schemes for ab initio total-energy calculations using a plane-wave basis set. Physical Review B, 54, 11169 (1996).
49. Kohn, W. et al. Self-Consistent Equations Including Exchange and Correlation Effects. Physical Review 140, A1133-A1138 (1965).
50. Perdew, J. P. et al. Generalized gradient approximation made simple. Physical review letters, 77, 3865 (1996).
51. Jain, A. et al. Commentary: The Materials Project: A materials genome approach to accelerating materials innovation. APL materials, 1 011002 (2003).
52. Evans, D. J. a et al. The nose-hoover thermostat. The Journal of chemical physics, 83 4069-4074 (1985).
53. Borodin, O. et al. Insights into the Structure and Transport of the Lithium, Sodium, Magnesium, and Zinc Bis(trifluoromethansulfonyl)imide Salts in Ionic Liquids. The Journal of Physical Chemistry C 122, 20108-20121 (2018).
54. Borodin, O. et al. Polarizable force field development and molecular dynamics simulations of ionic liquids. The Journal of Physical Chemistry B, 113, 11463-11478 (2009).
55. Andersson, R. et al. Dynamic Structure Discovery Applied to the Ion Transport in the Ubiquitous Lithium-ion Battery Electrolyte LP30. J Electrochem Soc 169, 100540 (2022).
56. Nan, B. et al. Enhancing Li+ Transport in NMC811∥Graphite Lithium-Ion Batteries at Low Temperatures by Using Low-Polarity-Solvent Electrolytes. Angewandte Chemie International Edition, 61, e202205967 (2022).
57. Borodin, O. et al. Quantum chemistry and molecular dynamics simulation study of dimethyl carbonate: ethylene carbonate electrolytes doped with LiPF₆. The Journal of Physical Chemistry B, 113 1763-1776 (2009).
58. Borodin, O. et al. Viscosity of a room temperature ionic liquid: predictions from nonequilibrium and equilibrium molecular dynamics simulations. The Journal of Physical Chemistry B, 113 4771-4774 (2009).
59. Wohde, F. et al. Li+ Transference Numbers in Liquid Electrolytes Obtained by Very-Low-Frequency Impedance Spectroscopy at Variable Electrode Distances. J Electrochem Soc 163, A714-A721 (2016).

Comparison of the state-of-the-art battery performances using micro-sized silicon as

[symbol]

We claim:

1. An electrolyte composition for lithium-ion batteries, said electrolyte composition comprising a solvent mixture and at least one lithium salt;
wherein said solvent mixture comprises a halogenated ether solvent, a halogenated carbonate solvent, and a sulfone solvent.

2. The electrolyte composition of claim 1, wherein said halogenated ether solvent is a fluorinated ether solvent.

3. The electrolyte composition of claim 2, where said fluorinated ether solvent is chosen from TTE, 1,1,2,2-tetrafluoroethyl-2,2,2-trifluoroethyl ether, 1,1,2,2-tetrafluoroethoxy) ethane, or perfluoroisobutyl methyl ether, and combinations thereof.

4. The electrolyte composition of claim 1, wherein said halogenated carbonate solvent is a fluorinated carbonate solvent.

5. The electrolyte composition of claim 4, wherein said fluorinated carbonate solvent is chosen from FEC, difluoroethylene carbonate, trifluoropropylene carbonate, or 4-[(2,2,3,3-tetrafluoropropoxy)methyl]-1,3-dioxolan-2-one, and combinations thereof.

6. The electrolyte composition of claim 1, wherein said sulfone solvent is chosen from dipropyl sulfone, dimethyl sulfone, butyl sulfone, or a cyclic sulfone solvent, and combinations thereof.

7. The electrolyte composition of claim 6, wherein said cyclic sulfone solvent is sulfolane.

8. The electrolyte composition of claim 1, wherein said solvent mixture comprises about 20% to about 80% of said halogenated ether solvent, by volume, about 0% to about 20% of said halogenated carbonate solvent, by volume, and about 10% to about 50% of said sulfone solvent, by volume.

9. The electrolyte composition of claim 1, wherein said at least one lithium salt is chosen from LiPF₆, LiFSI, LiBF₄, and LiDFOB, or combinations thereof.

10. The electrolyte composition of claim 1, wherein said at least one lithium salt is present at a concentration in the range of about 0.5 M to about 2 M.

11. A lithium-ion battery, said battery comprising a cathode, an anode, and the electrolyte composition of claim 1.

12. The battery of claim 11, wherein said anode is a microsized anode.

13. The battery of claim 11, wherein said anode comprises microsized Si, microsized Al, microsized Sn, microsized Bi, microsized alloys of Si, Al, Sn, Bi, or combinations thereof, or microsized alloys/carbon composites.

14. The battery of claim 11, wherein said anode comprises microsized Si, and said electrolyte composition comprises FEC, TTE, and sulfolane.

15. The battery of claim 14, wherein said FEC, TTE, and sulfolane are present at a volume ratio of 2:6:2, respectively.

16. A method of assembling a battery of claim 1, said method comprising layering a cathode, the electrolyte composition of claim 1, and an anode to obtain multiple layers.

17. The method of claim 16, wherein said cathode, then said electrolyte composition, then said anode are sealed in a battery casing.

18. The method of claim 17, wherein said battery casing is a coin cell or a pouch cell.
